(19) United States
(12) Patent Application Publication
(10) Pub. No.: US 2026/0332218 A1
(43) Pub. Date: Oct. 22, 2026

(54) MULTI-BEAMFORMER SOUNDING PROTOCOLS FOR WLAN SYSTEMS

(71) Applicant: InterDigital Patent Holdings, Inc., Wilmington, DE (US)

(72) Inventors: Zinan LIN, Basking Ridge, NJ (US); Hanqing LOU, Syosset, NY (US); Rui YANG, Melville, NY (US); Mahmoud SAAD, Montreal (CA)

(73) Assignee: InterDigital Patent Holdings, Inc., Wilmington, DE (US)

(21) Appl. No.: 19/549,537

(22) Filed: Feb. 25, 2026

Related U.S. Application Data
(63) Continuation of application No. 19/501,407, filed on Jul. 31, 2024.
(60) Provisional application No. 63/529,855, filed on Jul. 31, 2023.

(51) Int. Cl. H04B 7/06

(52) U.S. Cl. CPC H04B 7/0626; H04B 7/0617

(57) ABSTRACT

Methods are described for multi-beamformer sounding. A first method implemented in a first access point (AP) method may include: transmitting, to a second AP, a first null data packet (NDP) announcement (NDPA) frame for soliciting the second AP to transmit a first NDP frame; transmitting a first trigger frame; and receiving, in response to the first trigger frame, from one or more first stations (STAs) associated with the first AP, a first channel state information (CSI) report including CSI information based on the first NDP frame.

### CROSS REFERENCE TO RELATED APPLICATION

This application claims the benefit of U.S. Non-Provisional application Ser. No. 19/501,407 filed Jan. 12, 2026 which claims benefit of 371 of international phase Application No. PCT/US2024/040282 filed Jul. 31, 2024, which claims benefit of U.S. Provisional Application Ser. No. 63/529,855 filed Jul. 31, 2023, the contents of which are hereby incorporated by reference herein.

### BACKGROUND

In advanced wireless local area network WLAN systems, coordinated multi-access point (MAP) transmissions will be supported. Mechanisms may be defined to determine whether an access point (AP) is part of an AP candidate set and can participate as a shared AP in coordinated AP transmission initiated by a sharing AP. Procedures are needed for an AP to share its frequency/time resources of an obtained transmission opportunity (TXOP) with a set of APs. An AP that intends to use a resource (i.e., frequency or time) shared by another AP may indicate its resource needs to the AP that shared the resource.

MAP joint transmission or MAP coordinated beamforming may require larger channel state information (CSI) feedback overhead due to the CSI feedback from neighboring stations (STA) s. Multiple solutions have been proposed for MAP sounding feedback. However, they require multiple null data packet (NDPA) transmissions, e.g., master NDPA, NDPA from collaborating Aps, or occupy airtime for a long time if it is a sequential sounding feedback. Some existing MAP sounding protocols may limit the participation of legacy STAs, e.g., High Efficiency (HE) or Extremely High Throughput (EHT) STAs. Therefore, there is a need to have a simple sounding procedure, which requires a minimum change on the sounding protocol.

### SUMMARY

Aspects features and advantages of the disclosed embodiments, may address one or more of the foregoing needs or desires through methods and devices for preparing and transmitting a segmented compressed beamforming/channel quality indictor (CQI) report described hereinafter.

In embodiments, a method may be implemented in a first access point (AP), the method may include: transmitting a multibeamformer (MB) null data packet (NDP) announcement (NDPA) frame soliciting a second AP to transmit a second AP NDP; transmitting, by the first AP, a first AP NDP; and receiving, from a first station (STA) associated with the first AP, a channel status information (CSI) report including CSI information based on the first AP NDP and the second AP NDP. In further embodiments, the method may include: transmitting, by the first AP, a request to send (RTS); and receiving, by the first AP, a clear to send (CTS) from the second AP prior to the first AP transmitting the MB NDPA frame. Additionally/alternatively, the method may include transmitting, by the first AP, a trigger frame after the transmission of the first AP NDP, wherein the receiving the CSI report from the first STA occurs after the transmission of the trigger frame. Additionally/alternatively, the NDPA frame may include a special user field that includes an identification of the second AP. Additionally/alternatively, the special user field includes at least one of: a number of beamformees being solicited, a number of collaborating beamformers, a spatial stream allocation subfield, an NDP bandwidth subfield indicating a bandwidth of the NDP sent by the first AP, an NDP puncturing channel information subfield, an NDP signal (SIG) subfield, or a number of long training field (LTF) signals subfield indicating a number of LTF symbols carried in an NDP physical layer protocol data unit (PDDU). Additionally/alternatively, the special user field may include one or more STA information fields which are addressed to beamformees. Additionally/alternatively, one of the STA information fields may carry either common information shared by a plurality of collaborating beamformers or specific information for each of the plurality of collaborating beamformers. Additionally/alternatively, the first AP NDP may be transmitted a short interframe space (SIFS) after the MP NDPA frame is transmitted. Additionally/alternatively, the trigger frame may be transmitted a SIFS after the first AP NDP is transmitted.

In further embodiments, a first access point (AP) may include: a processor and a transceiver, the processor may be configured to cause the transceiver to: transmit a multibeamformer (MB) null data packet (NDP) announcement (NDPA) frame soliciting a second AP to transmit a second AP NDP; transmit a first AP NDP; and receive, from a first station (STA) associated with the first AP, a channel status information (CSI) report including CSI information based on the first AP NDP and the second AP NDP. In further embodiments, the processor may be configured to cause the transceiver to transmit a request to send (RTS) and to receive a clear to send (CTS) from the second AP prior to transmitting the MB NDPA frame. Additionally/alternatively the processor may be configured to cause the transceiver to transmit a trigger frame after the transmission of the first AP NDP and wherein the receiving the CSI report from the first STA occurs after the transmission of the trigger frame. Additionally/alternatively, the NDPA frame includes a special user field that includes an identification of the second AP. Additionally/alternatively, the special user field may include at least one of: a number of beamformees being solicited, a number of collaborating beamformers, a spatial stream allocation subfield, an NDP bandwidth subfield indicating a bandwidth of the NDP sent by the first AP, an NDP puncturing channel information subfield, an NDP signal (SIG) subfield, or a number of long training field (LTF) signals subfield indicating a number of LTF symbols carried in an NDP physical layer protocol data unit (PDDU). Additionally/alternatively, the special user field may include one or more STA information fields which are addressed to beamformers. Additionally/alternatively, one of the STA information fields may carry either common information shared by a plurality of collaborating beamformers or specific information for each of the plurality of collaborating beamformers. Additionally/alternatively, the processor may be configured to cause the transceiver to transmit the first AP NDP a short interframe space (SIFS) after the MP NDPA frame is transmitted. Additionally/alternatively, the processor may be configured to cause the transceiver to transmit the trigger frame a SIFS after the first AP NDP is transmitted.

In further embodiments, a method may be implemented in a station (STA) associated with a first access point (AP) including: receiving a first null data packet (NDP) from the first AP; receiving a second NDP from a second AP; and transmitting a channel status information (CSI) report including CSI information based on the first AP NDP and the second AP NDP. In further embodiments, the method may include receiving a trigger frame from the first AP and wherein transmitting the CSI report is performed after receiving the trigger frame.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example flow diagram of a process for a parent Multi-Beamformer (TMB) sounding sequence;

FIG. 3 is an example parent Multi-Beamformer (TMB) sounding sequence using trigger frame, soliciting one beamformee where the AP solicits its own associated non-AP STA to report the CSI feedback of its coordinated APs, e.g., AP1 solicits the STA11 to transmit the CSI feedback of AP1 and AP2;

FIG. 4 is an example parent Multi-Beamformer (TMB) sounding sequence with RTX/CTS enabled-soliciting one beamformee where the AP solicits its own associated non-AP STA to report the CSI feedback of its coordinated APs, e.g., AP1 solicits the STA11 to transmit the CSI feedback of AP1 and AP2;

FIG. 5 is an example Transparent Multi-Beamformer (TMB) sounding sequence-soliciting one beamformee (non-TB sounding sequence) where the AP solicits its own associated non-AP STA to report the CSI feedback of its coordinated APs, e.g., AP1 solicits the STA11 to transmit the CSI feedback of AP1 and AP2;

FIG. 6 is an example HE NDP Announcement frame format;

FIG. 7 is an example STA Info field format in an EHT NDP Announcement frame;

FIG. 8 is an example Trigger Frame Format;

FIG. 9 is an EHT Variant User Info field format;

FIG. 10 is an EHT Special User Info field format;

FIG. 11 is an example design of MB NDPA frame format;

FIG. 12 is an example design of the Special User Info field format in MB NDPA frame;

FIG. 13 is an example design of SS NDPA frame;

FIG. 14 is an is an example of the Special User Info field in the MB NDPA frame;

FIG. 15 is an example Enhanced EHT Variant User Info field in the Enhanced BFRP Trigger frame;

FIG. 16 is an example sequential NDP transmission from the soliciting AP and one collaborating beamformer-Single NDPA frame;

FIG. 17 is an example design of the Special User Info field format in the Enhanced NDPA frame-using NDP Transmission bitmap;

FIG. 18 is an example design of the Special User Info field format in the Enhanced NDPA frame-indicating the time gap;

FIG. 19 is an example of sequential NDP transmissions from the soliciting AP and one collaborating beamformer to one beamformee with multiple NDPA frames enabled;

FIG. 20 is an example design of the Special User Info field in the Enhanced NDPA frame used in Method 2 of Sequential NDP transmissions;

FIG. 21 is an example of sequential NDP transmissions from the soliciting AP and one collaborating beamformer to multiple beamformees with multiple NDPA frames enabled; and

FIG. 22 is an example Control Information subfield format in a AP2AP Buffer Report.

### DETAILED DESCRIPTION

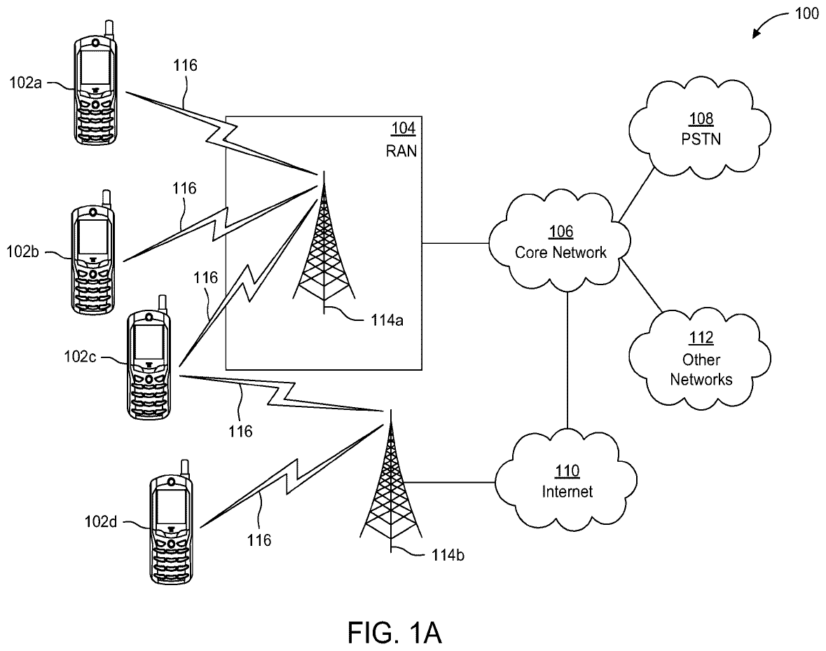

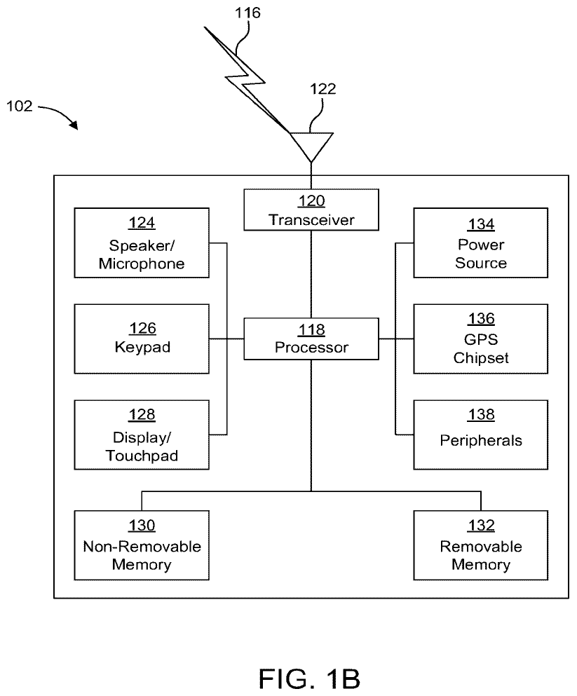

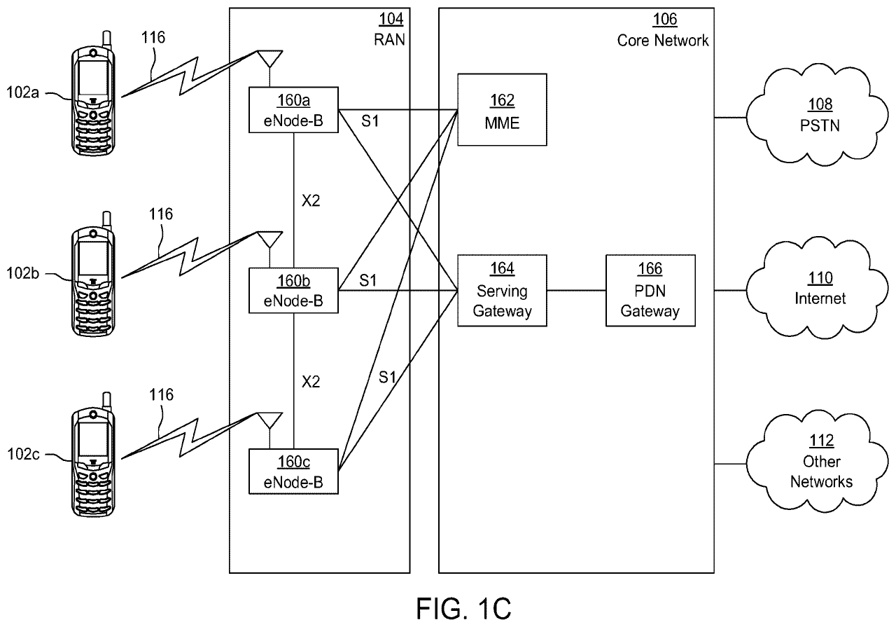

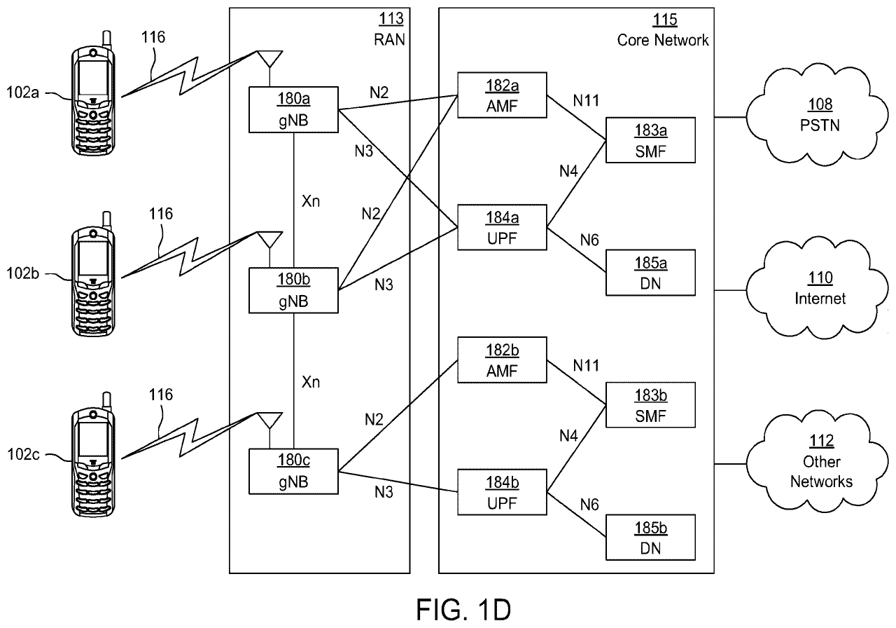

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface. The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time). The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANS, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

To improve spectral efficiency embodiments employ downlink Multi-User MIMO (MU-MIMO) transmission to multiple STA's in the same symbol's time frame, e.g. during a downlink OFDM symbol. In embodiments, downlink MU-MIMO may use the same symbol timing to multiple STA's interference of the waveform transmissions to multiple STA's is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

Embodiments may employ Extremely High Throughput (EHT). EHT further increases peak throughput and improves efficiency of the IEEE 802.11 networks. EHT addresses primary use cases and applications including high throughput and low latency applications such as Video-over-WLAN, Augmented Reality (AR) and Virtual Reality (VR).

EHT may include: Multi-AP, Multi-Band/multi-link, 320 MHz bandwidth, 16-Spatial Streams, hybrid automatic repeat request (HARQ), AP Coordination and new designs for 6-GHz channel access, among others.

EHT STAs use the EHT sounding protocol to determine the channel state information. The EHT sounding protocol provides explicit feedback mechanisms, defined as EHT non-trigger-based (non-TB) sounding and EHT trigger-based (TB) sounding, where the EHT beamformer (BFer) determines the channel state by transmitting a training signal (i.e., an EHT sounding null data packet (NDP) to the EHT beamformee (BFee), which sends back a transformed estimate of the channel state. The EHT beamformer uses this estimate to derive a steering matrix.

The EHT beamformee returns an estimate of the channel state in an EHT compressed beamforming/CQI report carried in one or more EHT Compressed Beamforming/CQI frames. There are three types of EHT compressed beamforming/CQI reports. For SU feedback, the EHT compressed beamforming/CQI report consists of an EHT Compressed Beamforming Report field. For MU feedback, the EHT compressed beamforming/CQI report consists of an EHT Compressed Beamforming Report field and EHT MU Exclusive Beamforming Report field. For CQI feedback, the EHT compressed beamforming/CQI report consists of an EHT CQI Report field.

Multi-AP Transmission may employ schemes for Coordinated multi-AP (C-MAP) transmissions including: Coordinated Multi-AP OFDMA; Coordinated Multi-AP TDMA; Coordinated Multi-AP Spatial Reuse; Coordinated beamforming/nulling; and Joint Transmission. In the context of coordinated Multi-AP, several terminologies have been defined including: Sharing AP—an EHT AP which obtains a TXOP and initiates the multi-AP coordination; Shared AP—an EHT AP which is coordinated for the multi-AP transmission by the sharing AP; and AP candidate set-a set of APs that may initiate or participate in multi-AP coordination.

Mechanisms to determine whether an AP is part of an AP candidate set and can participate as a shared AP in coordinated AP transmission initiated by a sharing AP are still being defined. Further, how an AP shares its frequency/time resources of an obtained TXOP with a set of APs is also being defined. An AP that intends to use the resource (i.e., frequency or time) shared by another AP will be able to indicate its resource needs to the AP that shared the resource. Coordinated OFDMA is supported in 11be, and in a coordinated OFDMA, both DL OFDMA and its corresponding UL OFDMA acknowledgement are allowed.

Channel sounding may be performed using two different schemes, explicit or implicit. In explicit channel sounding, the AP transmits an NDP to the STA with a preamble that allows the STA to measure its own channel and send channel status information (CSI) feedback to the AP. In implicit channel sounding, the STA sends an NDP, and the AP measures the channel of the STA assuming that the channel is reciprocal.

In embodiments, a maximum of 16-spatial streams may be supported for SU-MIMO and for MU-MIMO, the maximum number of spatial streams allocated to each MU-MIMO scheduled non-AP STA may be limited to four. The maximum number of users spatially multiplexed for DL transmissions is eight per resource unit (RU).

In embodiments, two modes of channel sounding in Multiple-AP may be supported, sequential sounding, and joint sounding. In sequential sounding, each AP transmits an NDP independently without overlapped sounding period of each AP. Also, joint sounding is provided as an optional mode for Multiple-AP, where when an AP has less or equal to a total of eight antennas, all antennas active on all long training field (LTF) tones and use a P-matrix across OFDM symbols.

The CSI feedback collection can be performed using 802.11ax-like 4-step sounding sequence (NDP announcement (NDPA)+NDP+beamforming report (BFRP) trigger frame (TF)+CSI report) in Multiple-AP to collect the feedback from both in-BSS and overlapping BSS (OBSS) STAs. Further, in sequential sounding for Multiple-AP, a STA can process an NDPA frame and the BFRP Trigger frame received from the OBSS AP and the STA can respond with the corresponding CSI to the OBSS AP, if polled by the BFRP TF from the OBSS AP.

In embodiments, channel sounding may be performed using two different schemes, explicit or implicit. In explicit channel sounding, the AP transmits an NDP to the STA with a preamble that allows the STA to measure its own channel and send CSI feedback to the AP. In implicit channel sounding, the STA sends an NDP, and the AP measures the channel of the STA assuming that the channel is reciprocal.

In embodiments a maximum of 16 spatial streams for SU-MIMO and for MU-MIMO may be supported where the maximum number of spatial streams allocated to each MU-MIMO scheduled non-AP STA is limited to 4. The maximum number of users spatially multiplexed for DL transmissions is 8 per RU/MRU.

In embodiments two modes of channel sounding in Multiple-AP may be supported, sequential sounding, and joint sounding. In sequential sounding, each AP transmits an NDP independently without an overlapped sounding period of each AP. Also, joint sounding shall also be provided as optional mode for Multiple-AP, where less or equal to total 8 antennas at AP has all antennas active on all LTF tones and use a P-matrix across OFDM symbols.

The CSI feedback collection may be performed using 4 step sounding sequence (NDPA+NDP+BFRP TF+CSI report) in Multiple-AP to collect the feedback from both in-BSS and OBSS STAs.

In sequential sounding for Multiple-AP, a STA can process the NDPA frame and the BFRP Trigger frame received from the OBSS AP and the STA can respond with the corresponding CSI to the OBSS AP, if polled by the BFRP TF from the OBSS AP.

A simplified sounding procedure is disclosed herein.

MAP joint transmission or MAP coordinated beamforming may require larger CSI feedback overhead due to the CSI feedback from neighboring STAs. Multiple solutions have been proposed for MAP sounding feedback. However, it requires multiple NDPA transmissions, e.g., master NDPA, NDPA from collaborating APs. Or it may occupy the airtime for a long time if it is a sequential sounding feedback. Furthermore, some existing MAP sounding protocols may limit the participation of legacy STAs, e.g., HE or EHT STAs. Therefore, there is a need to have a simple sounding procedure, which requires a minimum change on the sounding protocol.

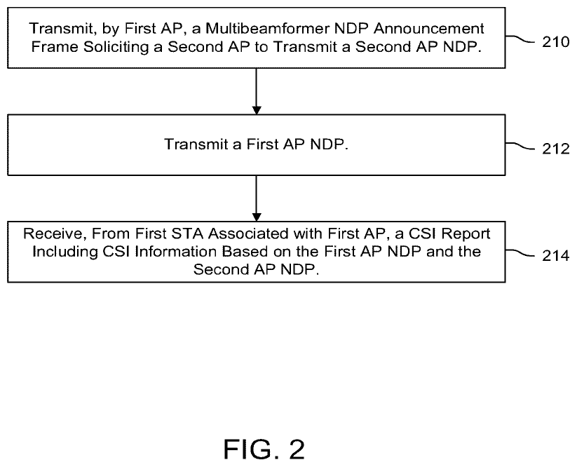

A multi-beamformer (MB) sounding procedure is described herein. In one embodiment, collaborating APs may coordinate to transmit the NDPs, e.g., transmit the NDPs using spatial multiplexing or transmit the NDP sequentially. FIG. 2 is an example process according to embodiments described in more detail herein. At 210, a first AP may transmit a Multibeamformer NDP announcement frame soliciting a second AP to transmit a second AP NDP. At 212, the first AP may transmit a first AP NDP. At 214, the first AP may receive, from a first STA associated with the first AP, a CSI report including CSI information based on the first AP NDP and the second AP NDP.

In embodiments, Transparent Multi-Beamformer (TMB) sounding procedures with spatial multiplexing NDP transmissions are described herein. In one embodiment, the NDPs from multiple beamformers, e.g., multiple APs, may be transmitted using spatial multiplexing scheme. To enable this coordinated NDP transmission among multiple beamformers, an enhanced NDPA frame, e.g., Multi-Beamformer (MB) NDP Announcement frame is transmitted by the AP which solicits the CSI information from its associated STA(s). The AP transmitting MB NDPA frame is called as a soliciting AP. The beamformer which transmits the NDP based on the MB NDPA frame indication is called as a collaborating beamformer.

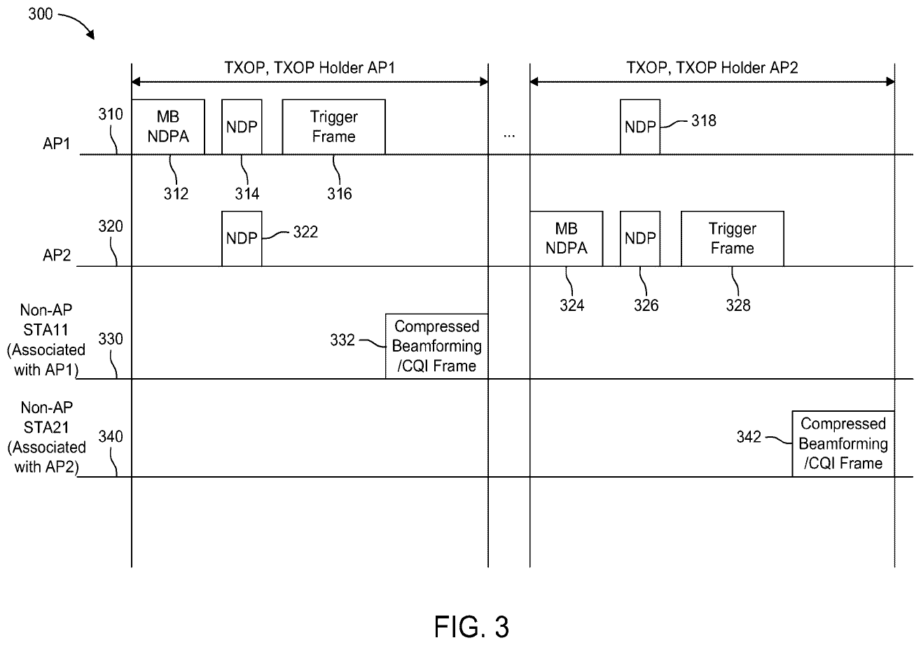

FIG. 3, 300 depicts an example procedure of Transparent Multi-Beamformer (TMB) sounding sequence. In this example, in the first sounding sequence, in which AP1 310 is the TXOP owner, there is one soliciting AP (AP1) and one collaborating beamformer (AP2) 320. STA11 330 which is associated with AP1 is solicited by AP1 via a MB NDPA frame 312 to report the CSI information of AP1 and AP2 to AP1. In the first TXOP owned by AP1, AP1 transmits MB NDPA frame first, followed by the NDPs transmitted from AP1 314 and AP2 322. In embodiments, the time gap between MB NDPA frame and NDP transmission may be one Short Interframe Space (SIFS). Upon reception of NDPs from AP1 and AP2, STA11 330 starts to measure the channels from AP1 and AP2. STA11 may not be aware the NDP transmissions are from two APs. SIFS after reception of the Trigger frame 316 transmitted by AP1, STA11 transmits the CSI feedback 332 to AP1. Similarly, in the second sounding sequence, which is the TXOP owned by AP2, AP2 is the soliciting AP and transmits the MB NDPA frame 324 to it associated STA, STA21 and the collaborating beamformer, AP1, after a SIFS followed by NDP transmissions from AP1 318 and AP2 326. In this MB NDPA frame, STA21 is solicited to measure the NDPs transmitted from AP1 and AP2 to its associated AP, AP2. SIFS after the reception of the Trigger frame 328 transmitted by AP2, STA21 is triggered to report the CSI information 342 based on the measurement of NDPs. In embodiments, the Trigger frame 328 may be a legacy EHT trigger frame or an Enhanced trigger frame which may be decodable by the legacy EHT STA or the enhanced collaborating beamformers, e.g., UHR APs. In addition, multiple STAs associated with each AP may report the CSI or compressed BF/CQI at the same time. STA11 and STA21 may not be aware that the NDP is transmitted from two different APs when they are being solicited by the corresponding MB NDPA frames.

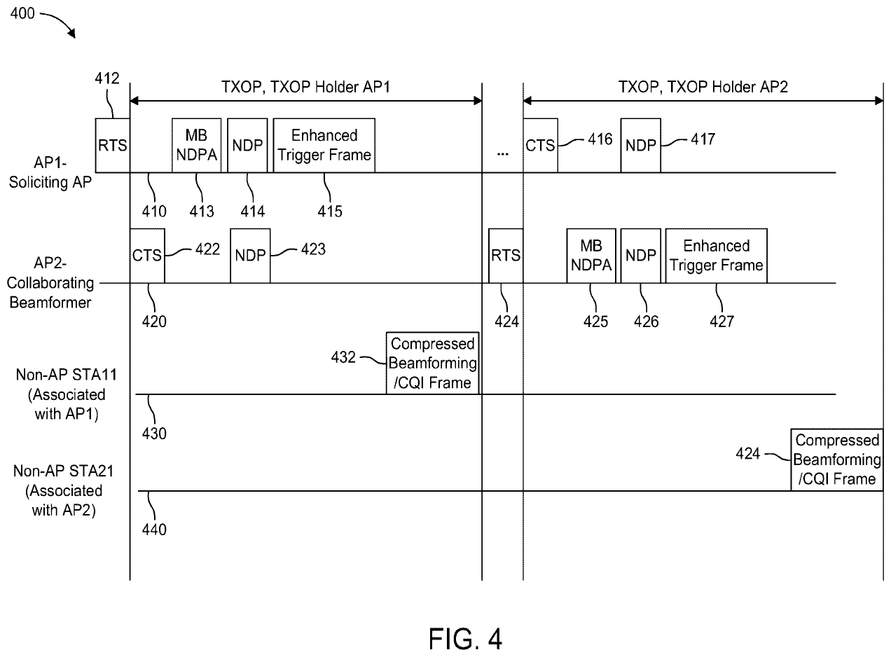

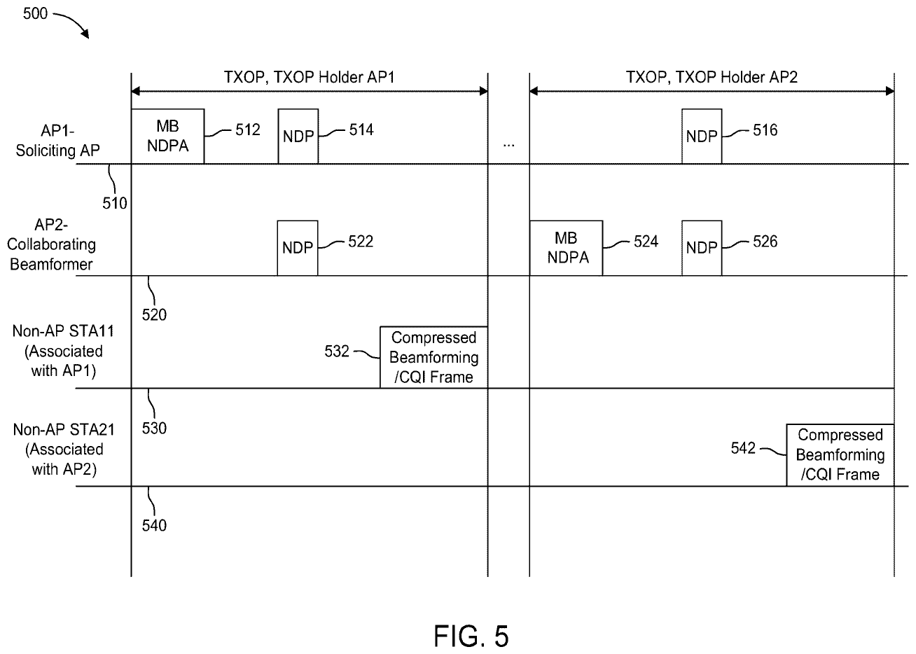

In further embodiments, to guarantee the collaborating beamformer is available to receive the MB NDPA frame and transmit NDP upon reception of the MB NDPA frame, RTS/CTS exchange between the soliciting AP, AP1 and the collaborating beamformer, AP2 may be performed before MB NDPA transmission. An example embodiment is shown in FIG. 4, 400. In a first sounding sequence of this example, AP1 410 first transmits RTS 412 to AP2. If AP1 does not receive the CTS 422 from AP2, either AP1 may not start a sounding procedure at all or AP1 may start the legacy sounding procedure which involves soliciting CSI information from STA11 420 by transmitting an NDPA frame and NDP. If AP1 does receive the CTS 422 from AP2, the sequence of events is as described above for FIG. 3, i.e. upon reception of NDPs from AP1 and AP2, STA11 430 starts to measure the channels from AP1 and AP2. STA11 may not be aware the NDP transmissions are from two APs. SIFS after reception of the Trigger frame 415 transmitted by AP1, STA11 transmits the CSI feedback 432 to AP1. A similar exchange sequence takes place when AP2 420 solicits its own associated STA, STA21 440 to report the CSI feedback based on the measurement of the NDPs 417, 426 transmitted from AP1 and AP2. The sequence of events, then is as described above for FIG. 3. I.e. SIFS after the reception of the Trigger frame 427 transmitted by AP2, STA21 is triggered to report the CSI information 442 based on the measurement of NDPs. It is AP1's decision to decide the number of collaborating beamformers. AP1 which transmits the MB NDPA 413 may not transmit the NDP 414 but only the collaborating beamformer(s) transmit the NDP. In addition, the collaborating beamformer may be a non-AP STA. The above procedure may be applicable to any type of CSI feedback, e.g., SU/MU compressing beamforming report, CQI, RSSI, interference, etc.

In further embodiments, there is no need to have a trigger frame transmitted by the soliciting AP if there is only one beamformee. However, due to the special design of an MB NDPA frame, it may require the STA that has capability to understand it is not an EHT NDP Announcement frame, but it is an MB NDP Announcement frame. In other words, if the MB NDP Announcement frame contains more than one STA Info field, the recipient STA may need to understand there is only one beamformee and no trigger frame follows the NDP. It needs to transmit the Compressed Beamforming/CQI frame SIFS after the recipient of the NDP. A description according to the example of FIG. 9 follows: In this example, in the first sounding sequence, in which AP1 510 is the TXOP owner, there is one soliciting AP (AP1) and one collaborating beamformer (AP2) 520. STA11 530 which is associated with AP1 is solicited by AP1 via a MB NDPA frame 512 to report the CSI information of AP1 and AP2 to AP1. In the first TXOP owned by AP1, AP1 transmits MB NDPA frame first, followed by the NDPs transmitted from AP1 514 and AP2 522. In embodiments, the time gap between MB NDPA frame and NDP transmission may be one Short Interframe Space (SIFS). Upon reception of NDPs from AP1 and AP2, STA11 530 starts to measure the channels from AP1 and AP2, STA11 then transmits the CSI feedback 532 to AP1. Similarly, in the second sounding sequence, which is the TXOP owned by AP2, AP2 is the soliciting AP and transmits the MB NDPA frame 524 to it associated STA, STA21 and the collaborating beamformer, AP1, after a SIFS followed by NDP transmissions from AP1 516 and AP2 526. In this MB NDPA frame, STA21 is solicited to measure the NDPs transmitted from AP1 and AP2 to its associated AP, AP2. STA21 reports the CSI information 542 based on the measurement of NDPs.

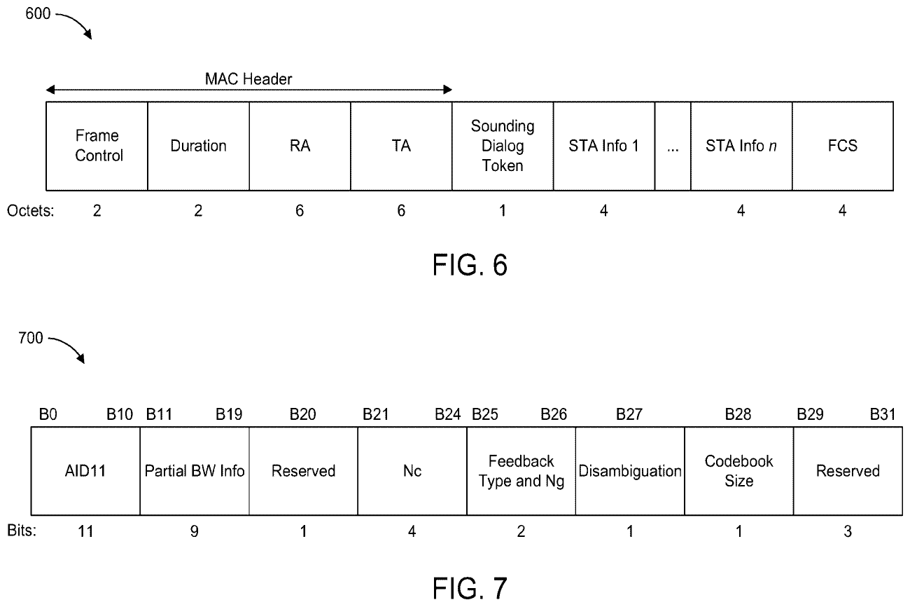

In embodiments, the structure of the NDP Announcement (NDPA) frame may be similar to the NDPA frame as illustrated by way of example in FIG. 6, 600. However, in embodiments, the STA Info field depicted in FIG. 7, 700, may be changed to accommodate the new features of EHT.

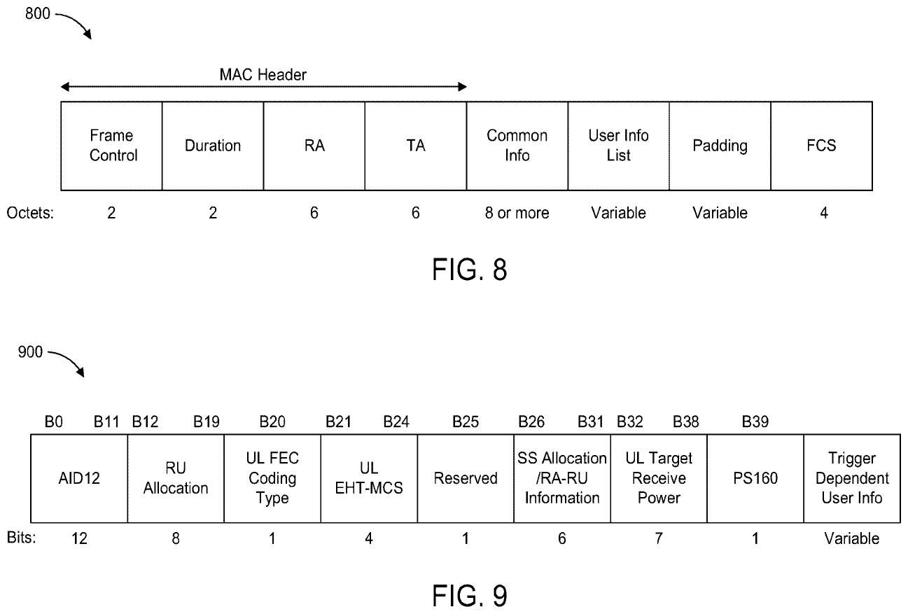

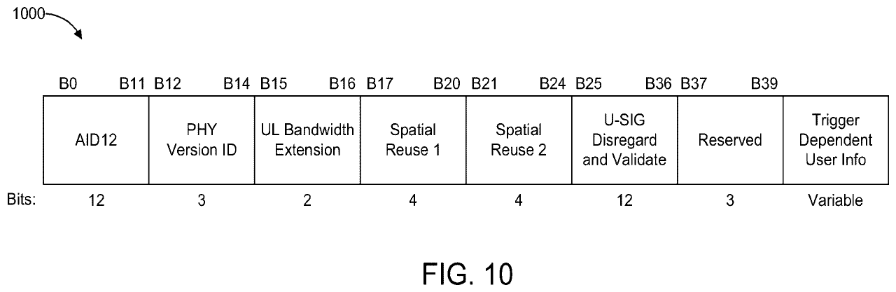

In embodiments, a trigger frame may be used to allocate resources and trigger single or multi-user access in the uplink. An example trigger frame format is shown in FIG. 8, 800. In embodiments, a variant of the User Info field may be used, and a Special User Info field may be added just after the Common Info field. Both enhancements as illustrated, for example, in FIG. 9, 900 and FIG. 10, 1000 allow a unified triggering scheme for both HE and EHT devices.

In a further embodiment, the MB NDP Announcement frame may carry the information related to the collaborating beamformers using a special user field that includes the information of a collaborating beamformer. In embodiments, the number of special user fields may be equal to the number of collaborating beamformers which transmit the NDP but do not transmit NDPA. In the example of FIG. 7, the number of the special user field is one. Table 1 shows the NDP Announcement frame variant encoding, in embodiments where the NDP Announcement Variant subfield in the sounding token subfield is set to 3, it indicates this NDPA may be a EHT NDP Announcement frame or MB NDP Announcement frame.

TABLE 1
NDP Announcement frame variant encoding

| NDP Announcement Variant | NDP Announcement frame |
|---|---|
| subfield | Variant |
| 0 | VHT NDP Announcement frame |
| 1 | Ranging NDP Announcement frame |
| 2 | HE NDP Announcement frame |
| 3 | EHT NDP Announcement frame/MB NDP |
| | Announcement frame |

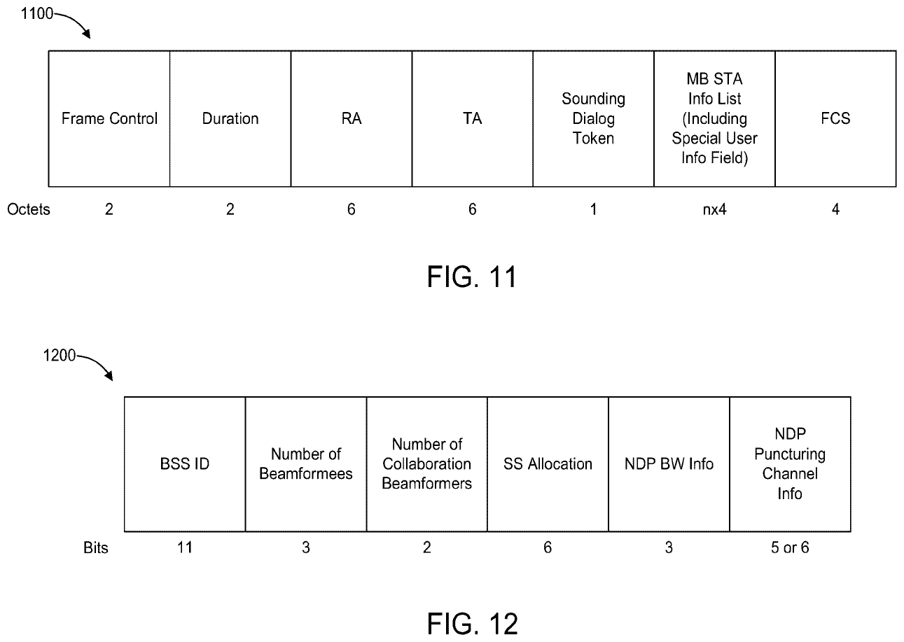

In one embodiment, the Special User field may have the same length as the EHT STA Info field. FIG. 11 depicts an example embodiment of an MB NDPA frame 1100. The MB STA Info List field contains one or more (n_bfmee) STA Info fields which are addressed to the beamformers and one or more (n_colloboratingbfmer) Special User Info fields which are addressed to the collaborating beamformers, where n=n_bfmee+n_colloboratingbfmer.

An example embodiment of the Special User field included in the MB NDPA frame is shown in FIG. 12, 1200. The Special User field 1200 contains the information of the collaborating beamfomer. In this embodiment, multiple information is included as follows:

Beamformer ID subfield indicates the beamformer ID, which may be the BSS ID corresponding to the collaborating beamformer that transmits the NDP with the soliciting AP. The length of this subfield may be same as the length of the AID11 subfield in the STA Info field in the MB NDPA frame, i.e., 11 bits. The value assigned in this Beamformer ID may not be used for the value set in the AID11 subfield of the STA Info field of the NDPA frame.

Number of Beamformees subfield indicates the number of beamformees which are solicited in the NDPA frame. This subfield may contain 3 bits.

Number of Collaborating Beamformers subfield indicates the number of collaborating beamformers that will transmit the NDP together. This subfield may contain 2 bits.

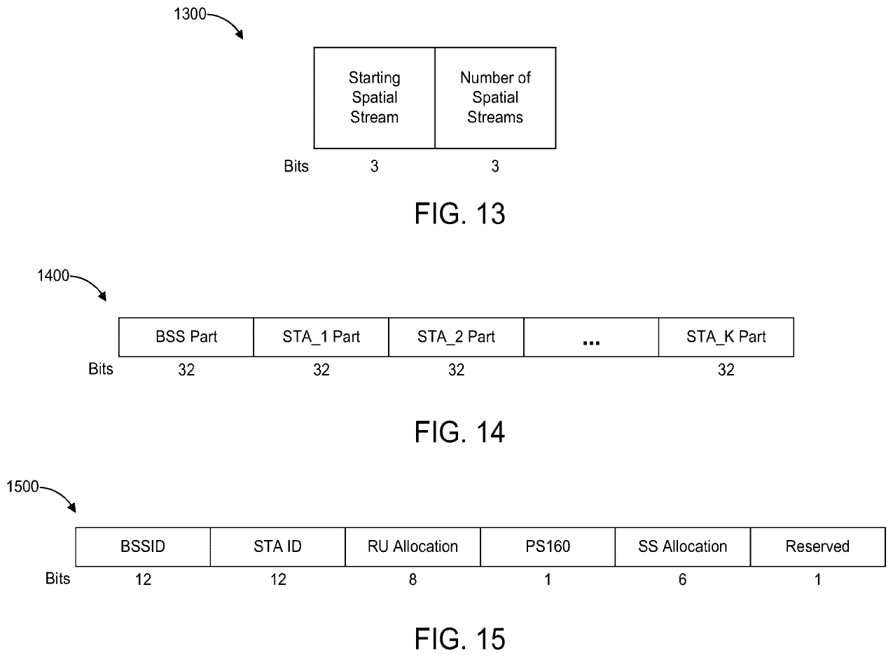

The SS Allocation subfield indicates the spatial streams used in the NDP transmitted by the targeting beamformer. This subfield may contain 6 bits. An embodiment of the SS Allocation subfield is shown in FIG. 13, 1300. Starting Spatial Stream subfield indicates the starting spatial and may be set to the starting spatial stream minus 1. The Number Of Spatial Streams subfield indicates the number of spatial streams used in the NDP transmitted by the targeting beamformer, and may be set to the number of spatial streams minus 1.

The NDP BW Info subfield indicates the bandwidth of the NDP transmitted by the targeting beamformer. For example, 000 represents the NDP bandwidth is 20 MHz; 001 represents the NDP bandwidth is 40 MHz; 010 represents the NDP bandwidth is 80 MHz; 011 represents the NDP bandwidth is 160 MHz; 100 represents the NDP bandwidth is 320 MHz; 101 represents the NDP bandwidth is 480 MHz.

The NDP Puncturing Channel Info subfield may indicate the puncturing information of used in the NDP transmitted by the targeting beamformer. Depending on the allowable puncturing pattern number and the maximum operating bandwidth, this subfield may contain 5 or 6 bits. In one method, this subfield may be used by the NDP transmitters to set the Punctured Channel Information field in SIG field in the NDP PPDU. In one method, the subfield may indicate the subchannels which satisfies all of the three following conditions: Subchannels within the operation channel width of the TXOP holder; Subchannels not available for the TXOP holder and; Subchannels not available for any NDP transmitter.

NDP SIG subfield: this subfield may indicate the necessary information for the transmitters of the NDP frames (e.g., APs) to set SIG field in NDP transmissions. Note, SIG fields from multiple APs in the concurrent NDP transmissions may be the same so that a receiver may decode them. For example, the NDP SIG subfield may include: PHY Version Identifier subfield may indicate the PHY version of the NDP PPDUs. With concurrent NDP transmissions, all the NDP transmitters or collaborating beamformers may use the same PHY Version Identifier. In one method, the setting of the subfield may depend on the capability of the beamformees. It may be set to the lowest value among the highest PHY version supported by a beamformee, i.e., PHY_VID=minₙ (highest PHY_VIDₙ), where n is the index of beamformees and highest PHY_VIDₙ refers to the highest PHY Version supported by the nth beamformee. For example, if some intended beamformees support UHR, EHT and PHY versions before EHT (and thus the highest support PHY version is UHR for them), and some intended beamformees may support EHT and PHY versions before EHT (and thus the highest supported PHY version is EHT for them), the PHY Version Identifier may be set to indicate EHT. BSS Color subfield may be set to indicate the TXOP holder's BSS color. This subfield may not present if the NDP transmitters know the BSS Color of the TXOP holder. In that case, the NDP transmitters (AP1 and AP2 in the examples) may always set the BSS Color field in the SIG field of the NDP PPDU to the BSS color of the TXOP holder.

A number of LTF Symbols subfield may indicate the number of LTF symbols carried in the NDP PPDU. Together with the SS Allocation subfield, the NDP transmitters or the collaborating beamformers may know if the TXOP holder may transmit a NDP frame implicitly. For example, AP2, as an NDP transmitter or collaborating beamformer, may be assigned to transmit using spatial stream 0 to 3 and the Number of LTF Symbols subfield may indicate 4 LTF symbols are carried in the NDP transmission, then AP2 may know AP1 (the TXOP holder) may not transmit NDP frame follow the MB NDPA frame. Alternatively, one field in the Special User Info field may indicate if the TXOP holder or the soliciting AP may transmit the NDP PPDU following the MB NDPA frame. Note, the soliciting AP may not always transmit the NDP PPDU following the NB NDPA frame. The NDP transmitter or collaborating beamformer may need to know this information to understand the feedback from the beamformee(s).

In embodiments, the MB NDPA frame may be also serve as a frame to synchronize the transmissions of NDPs from the coordinating beamformers, e.g., coordinating APs. In one method, the MB STA Info List field may include two kinds of Special User Info fields, a Common Special User Info field and a Individual Special User field. In embodiments, the Common Special User Info field may carry common information shared by all the collaborating beamformers, and the Individual Special User field may carry additional information for each collaborating beamformer. Subfields defined and mentioned for the Special User Info field may be split to these two kinds of Special User Info fields accordingly. In this embodiment, the collaborating beamformer may not necessarily be an AP. Instead, it may be a non-AP STA. The soliciting AP may use the procedures and signaling to solicit sounding between a pair of non-AP STAs.

In a further embodiment, the MB STA Info List field contains one or more (n_bfmee) STA Info fields which are addressed to the beamformees and one or more (n_colloboratingbfmer) Special User Info fields which are addressed to the collaborating beamformers, where n=nbfmee+Ncolloboratingbfmer×m. The Special User Info field's length may be m times as the STA Info field's length, where m≥1. FIG. 14 shows an example embodiment of a Special User Info field in the MB NDPA frame. In this example, m=K+1, where K is the total number of beamformees solicited in the MB NDPA frame. This type of Special User Info field may contains multiple parts: 1) BSS part which may be the same as shown in FIG. 11); 2) the STA information part which are the sounding related information indicated in the STA info field. Each STA Part may carry the following information: STA ID indicated in one STA Info field; The corresponding partial BW information indicated in the Partial BW Info subfield in the STA Info field; and The corresponding information indicated in the No Index subfield, Feedback Type And Ng subfield and Codebook Size subfield in the STA Info field.

In embodiments the trigger frame may be modified to have the collaborating beamformer obtain the information which is delivered from the soliciting AP and the beamformee(s).

In a first embodiment of modifying the trigger frame, one bit in the EHT variant Common Info field may be used to indicate if the BFRP trigger frame contains an enhanced EHT variant User Info field, which is addressed to the collaborating AP or not. For example, if the bit is set to 1, it represents there is at least one enhanced EHT variant User Infor field which is addressed to the collaborating AP; otherwise, all EHT variant User Info fields are addressed to the EHT STAs. An example format of the enhanced EHT variant User Info field in the Enhanced BFRP Trigger frame is shown in FIG. 15, 1500. This enhanced EHT variant User Info field is addressed to the collaborating beamformer. In this example, the BSSID subfield indicates the collaborating beamformer identifier, which needs to be different from the STA ID assigned to all possible STAs. The STA IDer subfield indicates the STA ID that will use the information included in this Enhanced EHT variant User Info field to transmit the beamforming report. The RU Allocation subfield and PS160 subfield, along with the UL BW subfield in the Common Info field, the UL BW Extension subfield in the Special User Info field, identify the size and location of an RU or MRU which is assigned to the STA whose ID is indicated in the STA ID subfield for the EHT TB PPDU transmission which carry the beamforming report/CQI. The SS Allocation subfield indicates the spatial streams of the solicited EHT TB PPDU transmitted by the STA identified in the STA ID subfield.

If there are N beamformees triggered, then N Enhanced EHT variant User Info fields may share the same BSSID. If there are M collaborating beamformers with N triggered beamformees, then this BFRP Trigger frame may contain M*N Enhanced EHT variant User Info fields.

In a further embodiment of modifying the trigger frame, without changing the current format of BFRP trigger frame, when the collaborating beamformer detects the BFRP Trigger frame transmitted from the soliciting AP, the collaborating beamformer may need to decode all the information included in the legacy EHT variant User Info field and understand which beamformees are triggered and what channel/spatial streams are assigned to the corresponding beamformee.

The soliciting AP may need to set the UL Target Receive Power to the maximum to have the collaborating beamformer to receive the EHT TB PPDU that carries the beamforming report from the triggered STA.

Embodiments for sequential NDP transmissions are described herein. There are multiple options to enable sequential NDP transmissions from collaborating beamformers.

For example, embodiments involving a single enhanced NDPA frame are described herein.

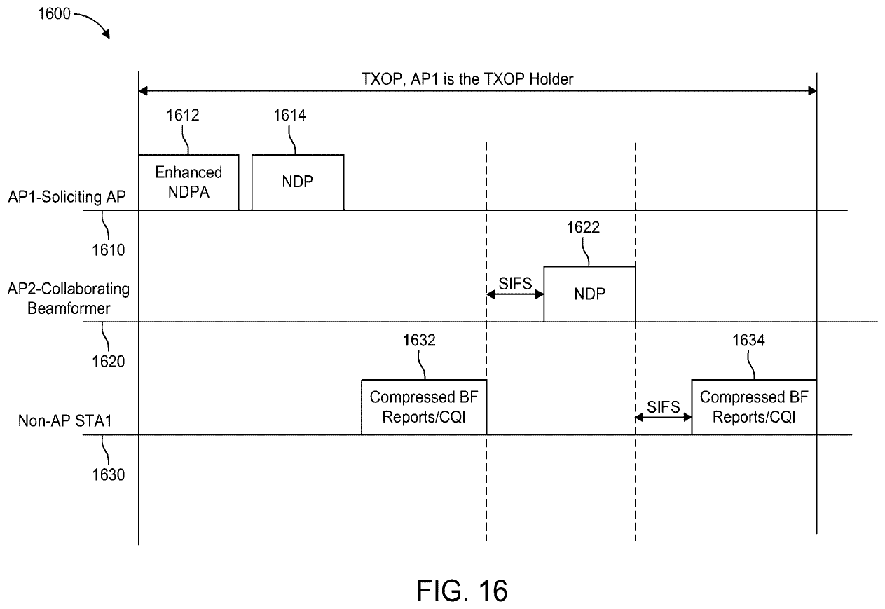

In one embodiment, to enable the sequential NDP transmissions from one or multiple collaborating beamformers the soliciting AP transmits an Enhanced NDPA frame to its associated non-AP STA, at the beginning of the sounding sequence. Right after each NDP transmission, the Compressed Beamforming/CQI frame is transmitted from the beamformee to the soliciting AP. The collaborating beamformer may also receive the Compressed Beamforming/CQI frame. After the first NDPA transmission, there is no more NDPA transmission during this sounding sequence owned by the soliciting STA. FIG. 16, 1600 shows an example of sequential NDP transmission from the soliciting AP 1610 and one collaborating beamformer, AP2 1620. In this example, the soliciting AP, AP1 owns the TXOP and transmits an Enhanced NDPA frame 1612 to its associated STA, STA1. The frame is also received and decoded by the collaborating beamformer, AP2. AP1 transmits the NDP 1614 SIFS after the Enhanced NDPA frame. SIFS after the reception of NDP from AP1, STA1 1630 will transmit the Compressed BF Reports/CQI frame 1632 to the soliciting AP, AP1 using the same channel on which NDP is transmitted. The NDP transmission 1622 from the collaborating beamformer, AP2 will be followed SIFS after the completeness of the Compressed BF Report/CQI frame from STA1. The channel used for the NDP transmission from AP2 should be same the channel used in the Enhanced NDPA frame and NDP transmissions from AP1. SIFS after the reception of the NDP from AP2, STA1 will feed back the Compressed Beamforming/CQI frame 1634 to AP1, which may be overheard by AP2.

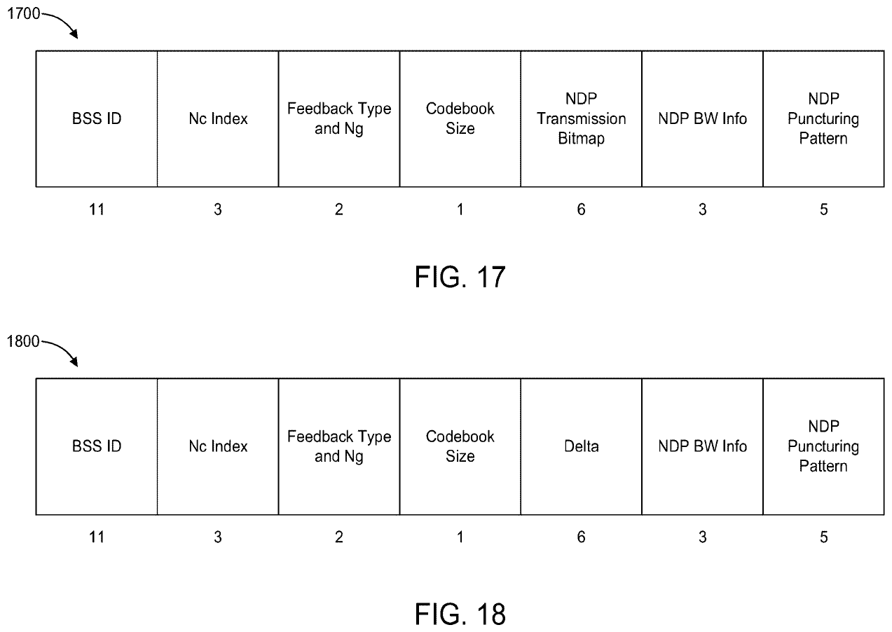

Similar to the design of the MB NDPA (e.g., FIG. 11), in embodiments, a Special User Info field may be included in the Enhanced NDPA frame. A Special User Info field is designated to one collaborating beamformer. It may include the NDP transmission order from the soliciting AP and one more multiple collaborating beamformers. One example of the enhanced NDPA frame format is shown in FIG. 17, 1700. The NDP Transmission Bitmap subfield may indicate the NDP order of the collaborating beamformer indicated by the BSS ID present in this Special User Info field. For example, if the value of NDP Transmission Bitmap is set to 100000, it implies that the collaborating beamformer identified by the BSS ID in this Special User Info field is the second one to transmit the NDP. The first NDP is transmitted by the soliciting AP. In other words, the transmission time will be SIFS after the first Compressed Beamforming/CQI frame transmitted from the beamformee. In this method, the number of special user field is equal to the number of collaborating beamformers which will transmit the NDP but not the NDPA frame.

In further embodiments, the transmission time may be indicated in the Special User Info field. FIG. 18, 1800 shows an example embodiment of the Special User Info field format in the Enhanced NDPA frame, which includes a Delta subfield. The Delta subfield is the time gap between the completeness of the enhanced NDPA frame transmission to the starting time of the NDP assigned to the beamformer identified in this Special User Info field. If the Enhanced NDPA transmission finishes at t1 and the delta time is t, then the NDP starting time for the collaborating beamformer identified in this Special User Info field is t1+t. The unit of the value used in the Delta subfield may be microsecond.

In embodiments, the collaborating beamformer may not hear the Enhanced NDPA (and/or NDP) transmission from the soliciting AP or the Compressed Beamforming/CQI frame from STA1 such that the collaborating beamformer is not able to transmit the NDP in its allocated time. In such a case, if the soliciting AP senses the channel idle longer than SIFS+delta during the TXOP, where delta may be one Slot time or multiple Slot times, the soliciting AP may grab the channel by the following options: Transmit a control frame, e.g., CF-end to indicate the TXOP is finished; or Use the remaining TXOP to perform DL transmission.

Transmission of multiple enhanced NDPA frames are described herein. In one embodiment, to enable the sequential NDP transmissions from one or multiple collaborating beamformers, the soliciting AP transmits an Enhanced NDPA frame before each NDP transmission from one collaborating beamformer. The NDP transmission from the soliciting AP or the collaborating beamformer starts SIFS after the enhanced NDPA frame. It occupies the same channel as the NDPA transmission. It may need to follow the puncturing channel pattern indicated in the NDPA frame or used by the NDPA frame. The beamformee which is the associated STA of the soliciting AP may feedback the Compressed Beamforming/CQI frame to the soliciting AP on the same channel as the one used for the enhanced NDPA and NDP transmissions.

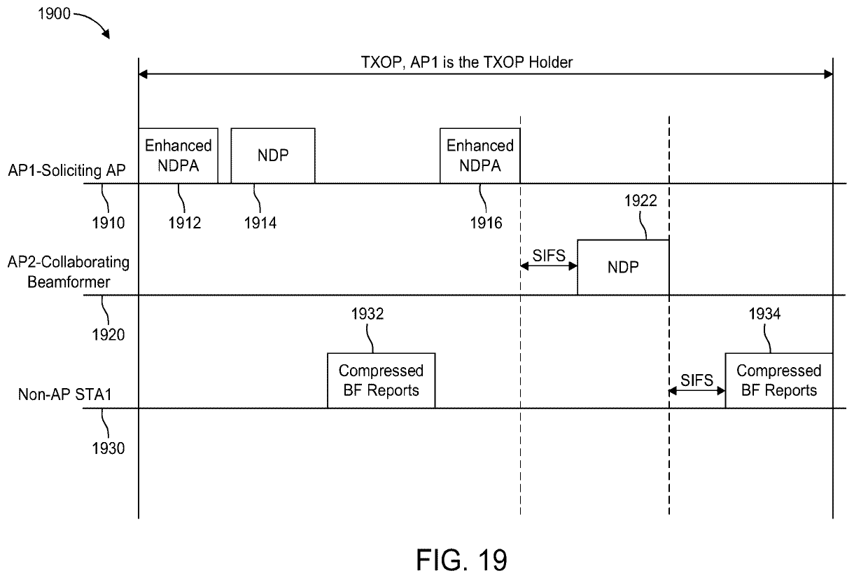

FIG. 19, 1900 shows example sequential NDP transmissions from the soliciting AP 1910 and one collaborating beamformer 1920 to one beamformee 1930 using this method. AP1 is the soliciting AP and transmits to its associated STA, STA1, an Enhanced NDPA frame 1912, which is followed by the NDP transmission 1914 from itself. SIFS after the completeness of the NDP transmission, STA1 feeds back the Compressed Beamforming/CQI frame 1932 to AP1 using the same channel as the enhanced NDPA and NDP transmission. SIFS after the reception of the Compressed Beamforming/CQI frame, the soliciting AP, AP1 sends out another Enhanced NDPA frame 1916 to STA1. The collaborating beamformer, AP2, transmits an NDP 1922 SIFS after the enhanced NDPA. In embodiments, the NDP transmission 1922 should follow the NDPA transmission channel and puncturing pattern. SIFS after the reception of the NDP, the STA transmits the Compressed Beamforming/CQI frame 1934 to AP1 using the same channel as the one used for NDPA and NDP transmission.

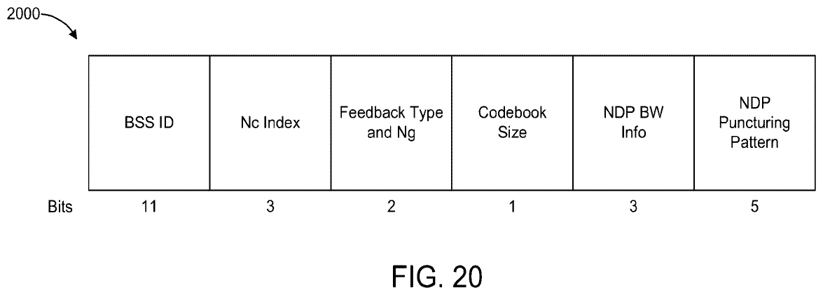

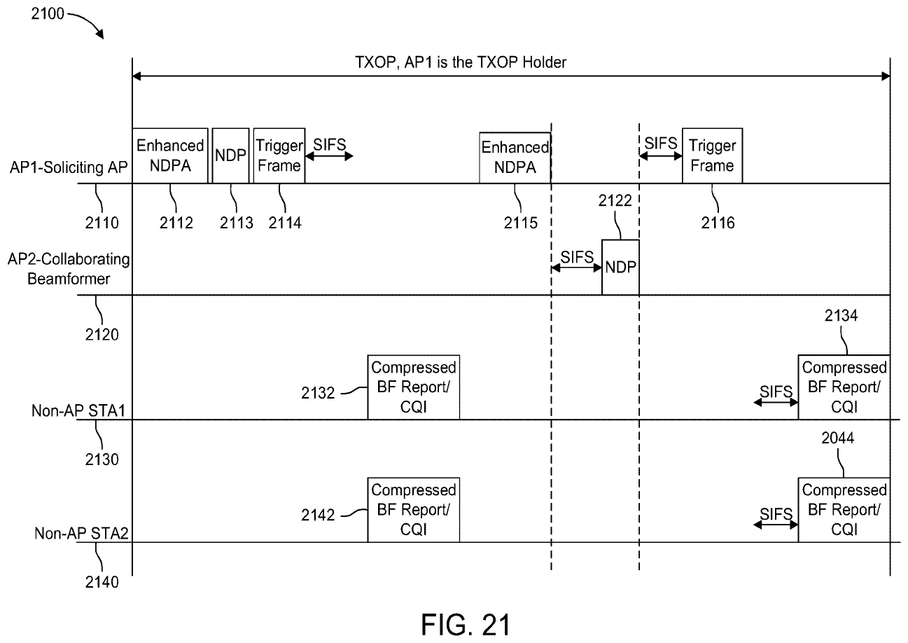

In embodiments, the Enhanced NDPA frame used in the above-described method, where multiple sequential enhanced NDPA frames are transmitted, may also include a Special User Info field which may have the same length as the EHT STA Info field in the EHT NDPA frame. The BSS ID may be carried in the Special User Info field. It is a special ID used to identify the collaborating beamformer, which is solicited to transmit the NDP SIFS after the enhanced NDPA frame transmission. If the NDP is transmitted from the same transmitter as the one transmitting the enhanced NDPA frame, the Special User Info field may not be present. It needs to be present when the transmitter of the NDP is different from the transmitter of the Enhanced NDPA frame. An example design of this Special User Info field is shown in FIG. 20, 2000. In embodiments, the NDP transmission from the collaborating beamformers may follow the values indicated in the NDP BW Info subfield and the NDP Puncturing Pattern subfield indicated in the Special User Info field.

In embodiments wherein multiple beamformees are solicited in the Enhanced NDPA frame, then a Trigger frame may be required to be sent from the soliciting AP. All of the beamformees may be the associated STAs with the soliciting AP, as shown in FIG. 21, 2100. FIG. 21, 2100, shows an example procedure of Transparent Multi-Beamformer (TMB) sounding sequence. In this example, in the first sounding sequence, in which AP1 2110 is the TXOP owner, there is one soliciting AP (AP1) and one collaborating beamformer (AP2) 2120. AP1 transmits a MB NDPA frame 2112 first, followed by an NDP 2113 transmitted from AP1 2110. Upon reception of the NDP 2113 STA1 2130 and STA2 2140 start to measure the channel from AP1. SIFS after reception of the Trigger frame 2114 transmitted by AP1, STA1 transmits the CSI feedback 2132 to AP1. STA2 also transmits CSI feedback 2142 to AP1. In the second sounding sequence, AP1 is the soliciting AP and transmits the MB NDPA frame 2115. After a SIFS NDP transmission 2122 is made from AP2 2120. SIFS after the reception of the Trigger frame 2116 transmitted by AP1, STA1 is triggered to report the CSI information 2034 based on the measurement of NDP. STA2 is also triggered to report the CSI information 2144 based on the measurement of NDP.

In embodiments, the collaborating beamformer may not hear the Enhanced NDPA transmission from the soliciting AP such that the collaborating beamformer is not able to transmit the NDP in its allocated time or the beamformees may not receive the NDP from the collaborating beamformers such that no Compressed Beamforming/CQI frame is transmitted from the beamformee. In such cases, if the soliciting AP senses the channel idle longer than SIFS+delta during the TXOP, where delta may be one Slot time or multiple Slot times, the soliciting AP may grab the channel by the following options: Transmit a control frame, e.g., CF-end to indicate the TXOP is finished; or Use the remaining TXOP to perform DL transmission. In further embodiments, the sounding sequences described herein may also be applicable to other type of reports, e.g., interference reports.

Embodiments for inter-AP communications are described herein. In embodiments, the two methods list below may be applicable and extended to other types of frame exchange between APs.

An Enhanced PPDU embodiment is described herein, wherein the MB-NDPA frame may be carried in an enhanced EHT PPDU or UHR PPDU with a modified data field. One bit in the Service field in the Data field may be used to indicate this PPDU is for inter-AP communication. Alternatively, this bit may be carried in the EHT/UHR PPDU preamble, e.g., U-SIG, to indicate this PPDU is for inter-AP communication.

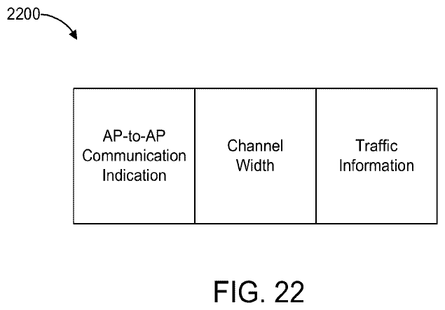

An Enhanced MAC header embodiment is described herein, wherein a special value may be assigned in the Control ID subfield in the A Control field type to indicate this MAC frame may carry the information for the inter-AP communication. For example, Control ID value 10, 11, 12, 13 or 14 may be used for the indication of inter-AP communication and the buffer status between APs, e.g., the meaning of this specific Control ID value is AP2AP Buffer Report. FIG. 22, 2200 shows an example Control Information subfield format in a AP2AP Buffer Report. AP-to-AP Communication Indication subfield is used to indicate if the PPDU carrying this frame is for AP-to-AP communication. For example, if it is set to 1, it may imply that this PPDU is for AP-to-AP communication. In other words, the recipient AP may need to decode the data field carried in this PPDU; if it is set to 0, it may imply that this PPDU may not be for AP-to-AP communication. However, the recipient AP may continue to get the information from the Channel Width subfield and the Traffic information. If AP-to-AP Communication Indication is set to 1, the Channel Width subfield may indicate the operating channel width for the PPDU exchange between APs from now on. For example, if AP-to-AP Communication Indication subfield is set 1 and Channel Width subfield indicates 160 MHz, it indicates the PPDU carrying this MB-NDPA frame or any other type of MAC frame occupies 40 MHz channel and the following PPDU exchange between the transmitting AP and the recipient AP(s) may use the same bandwidth as indicated in this subfield. The Traffic Information subfield may indicate the buffer status for the AP-to-AP communications. It may include the potential medium duration, the TID, latency bound, etc.

Capability indication is described herein. In one embodiment, one bit may be included in the UHR Capabilities element to indicate if the AP supports the collaboration with another AP, which may include the capability to 1) decode the MB NDPA frame or enhanced NDPA frame, the Enhanced BFRP Trigger frame etc; 2) and/or receive and decode the information carried in the Compressed Beamforming/CQI frame which is transmitted by the STA associated with another AP. The same bit may also be used to indicate if the non-AP STA is able to decode the MB NDPA frame or enhanced NDPA frame, the enhanced BFRP Trigger frame, etc. Another bit may be included in the UHR Capabilities element to indicate if the non-AP STA is able to transmit and/or receive information from the AP which is not its associated AP.

Beamforming report collection is described herein. Embodiments for how the collaborating beamformers may obtain the beamforming report transmitted from the beamformee are described.

Embodiments involving a beamforming report forwarded by the soliciting AP are described. In one embodiment, the soliciting AP may obtain the CSI Information, extract the parts belong to the channel between itself and the beamformee and forward other parts of the CSI information to the corresponding beamformer.

In one embodiment, described below, a soliciting AP may extract the channel between itself and the beamformee from CSI reports if the NDPs are spatial multiplexed:

Assume there are two APs, AP1 with Nₜₓ₁ transmit antennas and AP2 with Nₜₓ₂ transmit antennas. AP1 is the soliciting AP and the serving AP of STA1. STA1 has Nᵣₓ receive antennas. The transmissions of NDPs from AP1 and AP2 are spatial-multiplexed. Nᵣₓ≤Nₜₓ₁+Nₜₓ₂.

First, at the beamformee side, STA1 estimates the combined H through the received NDPs as follows:

H(Nᵣₓ×(Nₜₓ₁+Nₜₓ₂)=U(Nᵣₓ×Nᵣₓ)S(Nᵣₓ×Nᵣₓ)(V*)Nᵣₓ×(Nₜₓ₁+Nₜₓ₂)

Next, STA1 feeds back the angle indices of φ's and ψ's, and eigenvalues, S to the soliciting AP, AP1.

Next, AP1 applies all angle indices, which contain the channel information between AP1 and STA1 and the channel information between AP2 and STA2, to reconstruct V. After that it uses V and the eigenvalues, S, to reconstruct its own channel Hᵣ₁ as follows:

Hᵣ=SV̅*; Hᵣ₁ is the first Nₜₓ₁ columns of Hᵣ. V̅ᵣ₁ is obtained by operating SVD on Hᵣ₁. In other words, V̅ᵣ₁ is the precoding matrix recovered by AP1. The remaining Nₜₓ₂ columns of Hᵣ represent the channel between the collaborating beamformer AP2 and the beamformee STA1, Hᵣ₂.

Next, There are multiple embodiments for the soliciting AP to determine how it forwards the results to the collaborating beamformer(s), including:
A) Forwarding all the received information, e.g., all angle indices φ's and ψ's and eigen values, S to the collaborating beamformer(s) and the delta SNR required in MU feedback if MU feedback is required.
B) Performing reconstruction of Hᵣ₂ and forward the elements of Hᵣ₂ to AP2.
C) Performing reconstruction of Hᵣ₂ and SVD on Hᵣ₂ to obtain the precoding matrix, Vᵣ₂. Forward the elements of V̅ᵣ₂ to the AP2 or forward the angle indices of φ's and ψ's after performing Givens Rotation on V̅ᵣ₂.

In embodiments, the soliciting AP may also use the received beamforming report to determine if the beamformee has received the NDP from the collaborating beamformer. For example, in embodiments, if the elements in Hᵣ₂ are lower than certain threshold, the soliciting AP may decide that the solicited beamformee does not receive the NDP from the collaborating beamformer, AP2. It may imply that the beamformee is not within the overlapping area of AP1 and AP2. In this case, there is no need for the soliciting AP to forward the beamforming report to AP2.

Embodiments involving Direct Collection from the beamformee are described herein.

In one embodiment of direct collection from the beamformee, cases where the NDPs are transmitted by the soliciting AP and the collaborating beamformer(s) via spatial multiplexing are considered. The collaborating beamformer may base on its SS location indicated in the MB NDPA to extract the beamforming reports directly if it detects the Beamforming Report/CQI frame is sent from the beamformee(s) indicated in the MB NDPA. The collaborating beamformer may rely on the transmitter address indicated in the MAC header to determine if the transmitter address matches the STA address indicated in the MB NDPA frame. If yes, then the frame is transmitted from the beamformee; otherwise, the frame is not sent from the beamformee. Furthermore, if the frame is transmitted SIFS after NDP or it is transmitted SIFS after the trigger frame if there is a trigger frame after NDP, the collaborating beamformer may further confirm this frame is the Compressed Beamforming/CQI frame.

In further embodiments of direct collection from the beamformee, if the trigger frame indicates the frame transmissions to different beamformers including the soliciting AP and the collaborating beamformers are assigned to different channels. Then the collaborating beamformer may monitor the channel assigned for the Compressed Beamforming/CQI frame transmission from the beamformee to the beamformer and extract the channel information from the Beamforming/CQI frame.

In the above-described embodiments, the terms CSI report and compressed beamforming/CQI report are mutually exchangeable.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this scenario and are applicable to other wireless systems as well. Although SIFS is used herein to indicate various inter frame spacing in the examples of the designs and procedures, other inter frame spacing such as reduced interframe spacing (RIFS), arbitration interframe spacing (AIFS), distributed coordination function (DCF) interframe spacing DIFS or other agreed time intervals may be applied in further embodiments. Although four RBs per triggered TXOP are shown in some figures as example herein, the actual number of RBs/channels/bandwidth utilized may vary in embodiments. In addition, although specific bits are used in embodiments described to signal in-BSS/OBSS as examples, other bits may be used to signal this information.

What is claimed:

1. A method implemented in a first access point (AP), the method comprising:
transmitting, to a second AP, a first null data packet (NDP) announcement (NDPA) frame for soliciting the second AP to transmit a first NDP frame;
transmitting a first trigger frame; and
receiving, in response to the first trigger frame, from one or more first stations (STAs) associated with the first AP, a first channel state information (CSI) report including CSI information based on the first NDP frame.

2. The method of claim 1, further comprising:
transmitting a second NDPA frame;
transmitting a second NDP frame;
transmitting a second trigger frame; and
receiving, in response to the second trigger frame, from the one or more first STAs associated with the first AP, a second CSI report including CSI information based on the second NDP frame.

3. The method of claim 1, wherein the first NDPA frame includes a first user field that includes:
a bandwidth subfield indicating a bandwidth of NDPs transmitted by the second AP,
a puncturing channel information subfield,
a basic service set (BSS) color indication,
a number of spatial streams for NDPs, or
an information field indicating a starting spatial stream.

4. The method of claim 2, wherein the second NDPA frame includes a first user field that includes:
a bandwidth subfield indicating a bandwidth of NDPs transmitted by the first AP,
a number of spatial streams for NDPs, or
an information field indicating a starting spatial stream.

5. The method of claim 1, further comprising:
monitoring for the first NDP frame and
transmitting the first trigger frame a short interframe space (SIFS) after the reception of the first NDP frame.

6. The method of claim 2, wherein the second NDP frame is transmitted a SIFS after the transmission of the second NDPA frame.

7. The method of claim 2, wherein the second trigger frame is transmitted a SIFS after the transmission of the second NDPA frame.

8. A first access point (AP) comprising:
a processor and
a transceiver,
the processor configured to cause the transceiver to:
transmit, to a second AP, a first null data packet (NDP) announcement (NDPA) frame for soliciting the second AP to transmit a first NDP frame;
transmit a first trigger frame; and
receive, in response to the first trigger frame, from one or more first stations (STAs) associated with the first AP, a first channel state information (CSI) report including CSI information based on the first NDP frame.

9. The first AP of claim 8, wherein the processor is further configured to cause the transceiver to:
transmit a second NDPA frame;
transmit a second NDP frame;
transmit a second trigger frame; and
receive, in response to the second trigger frame, from the one or more first STAs associated with the first AP, a second CSI report including CSI information based on the second NDP frame.

10. The first AP of claim 8, wherein the first NDPA frame includes a first user field that includes:
a bandwidth subfield indicating a bandwidth of NDPs transmitted by the second AP,
a puncturing channel information subfield,
a basic service set (BSS) color indication,
a number of spatial streams for NDPs, or
an information field indicating a starting spatial stream.

11. The first AP of claim 9, wherein the second NDPA frame includes a first user field that includes:
a bandwidth subfield indicating a bandwidth of NDPs transmitted by the first AP,
a number of spatial streams for NDPs, or
an information field indicating a starting spatial stream.

12. The first AP of claim 8, wherein the processor is further configured to cause the transceiver to:
monitor for the first NDP frame and
transmit the first trigger frame a short interframe space (SIFS) after the reception of the first NDP frame.

13. The first AP of claim 9, wherein the second NDP frame is transmitted a SIFS after the transmission of the second NDPA frame.

14. The first AP of claim 9, wherein the second trigger frame is transmitted a SIFS after the transmission of the second NDPA frame.
